(19) United States
(12) Patent Application Publication
(10) Pub. No.: US 2022/0408168 A1
(43) Pub. Date: Dec. 22, 2022

(54) MAGNETICALLY ATTRACTABLE BLUETOOTH SPEAKER

(71) Applicant: Shenzhen Hali-Power Industrial Co., Ltd., Shenzhen (CN)

(72) Inventors: XIAOMIN ZHU, Shenzhen (CN); TAO ZOU, Shenzhen (CN); YAJIAN LIU, Shenzhen (CN); HANQIAO ZHANG, Shenzhen (CN); FANG CHENG, Shenzhen (CN); YICHAO FAN, Shenzhen (CN); Dan Cass, St. Clair, MI (US)

(21) Appl. No.: 17/450,462

(22) Filed: Oct. 10, 2021

(30) Foreign Application Priority Data
Jun. 17, 2021 (CN) 202121349447.1

(51) Int. Cl. H04R 1/02; H04W 4/80

(52) U.S. Cl. CPC H04R 1/021; H04W 4/80; H04R 1/026; H04R 1/028; H04R 2420/07

(57) ABSTRACT

A magnetically attractable Bluetooth speaker is disclosed, including a speaker housing, a loudspeaker, a control circuit board, and a magnet. The loudspeaker is electrically connected to the control circuit board. The speaker housing includes a limiting part for securing the magnet. The magnet is fixedly arranged in the limiting part, and the magnet is arranged outside the magnetic circuit range of the loudspeaker. With such a structure, by arranging the magnet in the speaker housing, the user experience of the speaker can be greatly improved, so that the user can place it in different manners depending on their different needs. Compared with the traditional ordinary speakers that can only be placed on a horizontal plane or a surface with a small slope, the speaker provided by the present disclosure has better flexibility in use.

### CROSS-REFERENCE TO RELATED APPLICATIONS

This is a U.S. patent application which claims the priority and benefit of Chinese patent application number 202121349447.1, filed on Jun. 17, 2021, the disclosure of which is incorporated herein by reference in its entirety.

### TECHNICAL FIELD

This disclosure relates to the technical field of Bluetooth speakers, and more particularly relates to a magnetically attractable Bluetooth speaker.

### BACKGROUND

As people are having increasingly higher requirements for the quality and experience of outdoor fitness and entertainment activities, Bluetooth speakers are becoming more and more popular. People can play different kinds of audio through a Bluetooth speaker anywhere to create a better atmosphere. With existing Bluetooth speaker products, although people can easily connect to the Bluetooth speaker to play audio, they generally can only be placed on e.g., a table top or a platform, and cannot be attached to the wall or placed upside down in the air, making it poorly flexible in different usage scenarios and unable to be placed at will, resulting in unsatisfactory user experience.

### SUMMARY

In order to solve the above problems, the present disclosure provides a magnetically attractable Bluetooth speaker, which includes a speaker housing, a loudspeaker, a control circuit board, and a magnet. The loudspeaker is electrically connected to the control circuit board. The speaker housing includes a limiting part for securing the magnet, and the magnet is fixedly arranged in the limiting part, and the magnet is arranged outside the magnetic circuit range of the Bluetooth speaker.

In some embodiments, the speaker housing includes a grille, a speaker body, and a speaker bottom plate. The grille is connected to the upper end of the speaker body. The sound outlet of the speaker is oriented toward the grille. The limiting part includes an upper cavity disposed at the bottom of the speaker body and a lower cavity arranged on the bottom plate of the speaker.

In some embodiments, further included is a button assembly, which is made of an elastic material. The speaker housing defines a button hole for mounting the button assembly. The button assembly includes a button and a connecting arm, and the speaker housing includes a connecting bump that operates in cooperation with the connecting arm. The button is fixedly connected to the connecting bump through the connecting arm, and the button is arranged in the button hole. The control circuit board includes a key switch that operates in cooperation with the button.

In some embodiments, the button assembly further includes a button lamp circuit board, which includes luminous lamp beads, and which is electrically connected to the control circuit board. The button lamp circuit board is fixedly arranged on the button, and the button is provided with a light-transmitting area, and the light emitted by the light-emitting lamp beads is operative to pass through the light-transmitting area.

In some embodiments, the speaker body is provided with a positioning platform for installing the speaker housing, and the positioning platform defines a fixing hole allowing the loudspeaker to partially pass through.

In some embodiments, the control circuit board includes a through hole that allows the loudspeaker to partially pass through.

In some embodiments, the sound box housing is horn-shaped.

In some embodiments, further included is a battery for supplying power to the control circuit board, where the battery is a lithium polymer battery.

In some embodiments, a charging interface for charging the battery is arranged on the control circuit board, and a charging hole matched with the charging interface is defined in the speaker housing.

In some embodiments, a silicone pad is further included, which is fixedly arranged on the bottom of the speaker housing.

Compared with the related art, this disclosure may have the following beneficial effects. The disclosure can greatly improve the user's experience of using the speaker through the magnet arranged in the speaker housing, so that the user can place the speaker in different manners as per their different needs. In contrast with traditional speakers can only be placed on a horizontal plane or a surface with a lower slope, the speaker provided by the present disclosure has better flexibility in use.

### BRIEF DESCRIPTION OF DRAWINGS

To better illustrate the technical solutions according to embodiments of this disclosure or in the related art, the accompanying drawings required in the description of the embodiments herein or the related art will now be briefly described. Apparently, the accompanying drawings in the following description show merely some embodiments of this disclosure, and those of ordinary skill in the art will be able to obtain other drawings based on these drawings without making creative efforts, where in the drawings:

FIG. 1 is a schematic diagram illustrating the structure of the produce according to the present disclosure.

FIG. 2 is a schematic diagram illustrating the structure of the product according the present disclosure from another angle.

FIG. 3 is an exploded schematic diagram of the product according to the present disclosure.

### REFERENCE SIGNS USED IN THE ACCOMPANYING DRAWINGS

1. Speaker housing; 2. Loudspeaker; 3. Control circuit board; 4. Magnet; 11. Grille; 12. Speaker body; 13. Speaker bottom plate; 121. Positioning protrusion; 31. Through hole; 131. Circular boss; 132. Annular positioning groove; 5. Button assembly; 51. Button; 52. Connecting arm; 53. Button lamp circuit board; 511. Light transmission area; 6. Battery; 32. Button Switch; 33. Charging interface; 121. Button hole; 122. Charging hole; 7. Dust plug; 8. Silicone pad.

### DETAILED DESCRIPTION

Technical solutions embodied in the embodiments of this disclosure will now be clearly and comprehensively described in connection with the accompanying drawings for these embodiments. Apparently, the described embodiments are merely some but not all embodiments of this disclosure. All other embodiments obtained by persons of ordinary skill in the art based on the embodiments of this disclosure without making creative efforts shall all fall within the protection scope of the present disclosure.

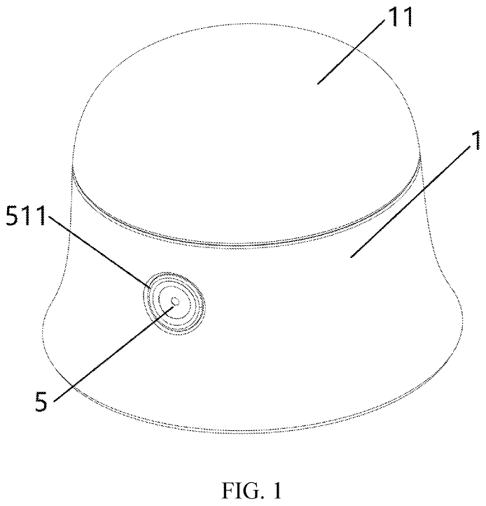

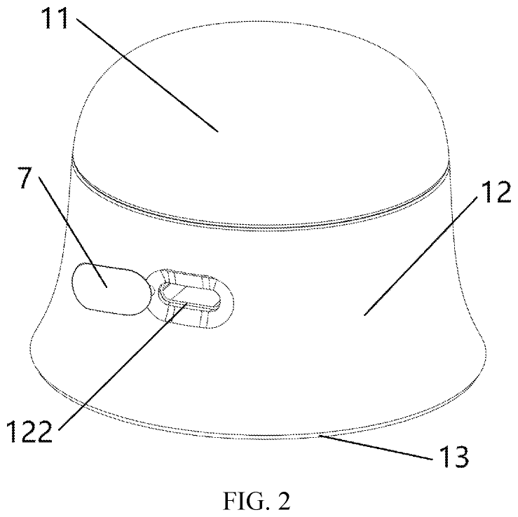

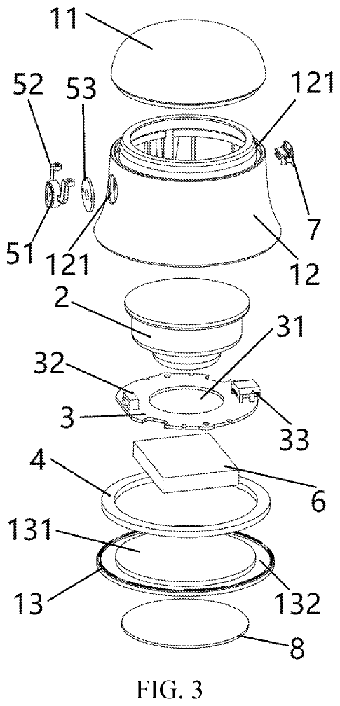

As illustrated in FIGS. 1-3, the present disclosure provides a magnetically attractable Bluetooth speaker, which includes a speaker housing 1, a loudspeaker 2, a control circuit board 3, and a magnet 4. The loudspeaker 2 is electrically connected to the control circuit board 3. The magnet 4 is arranged outside the magnetic circuit range of the Bluetooth speaker 2. The speaker housing 1 includes a limiting part for securing the magnet 4, which is fixedly arranged in the limiting part.

By arranging the magnet 4 in the speaker housing 1, the speaker can be used more flexibly and can be placed in any position.

When the table top is made of metal, the speaker can be attached to any place, including side panels, bottom panels, or sloped surfaces.

When the table top is made of a non-metallic material, it is only needed to first fix a metal material on the table top, and then attach the speaker to the metal material, which can also improve the flexibility of speaker placement.

It can also be attached to the back of the mobile phone to act as a stand for the mobile phone. When the mobile phone is capable of magnetic attraction function, the speaker can be directly attached to the magnetic attraction part of the mobile phone. When the mobile phone has no magnetic attraction function, just first attach the metal material that matches the speaker to the back of the phone, and then attach the speaker to the metal material.

The metal material is used as the medium that attracts with the speaker, which can flexibly meet the user's needs for the use of the speaker.

Compared with traditional ordinary speakers, that can only be placed on a horizontal plane or a surface with a low slope, and the present disclosure provides better user experience.

The speaker housing 1 includes a grille 11, a speaker body 12, and a speaker bottom plate 13. The grille 11 is made of stainless iron. The speaker bottom plate 13 is ultrasonically welded to the speaker body 12. The lower end of the grille 11 is provided with a positioning groove. The upper end of the speaker body 12 is provided with a positioning protrusion 121 that cooperates with the positioning groove at the lower end of the grille 11. The fixed connection between the grille 11 and the speaker body 12 is realized by snapping the positioning protrusion 121 into the positioning groove.

The speaker body 12 is provided with a securing platform for installing the loudspeaker 2, where the sound outlet of the loudspeaker 2 is oriented toward the grille 11, and the securing platform is provided with a fixing hole allowing the loudspeaker 2 to partially pass through.

The design of the fixing hole in the positioning platform allows the loudspeaker 2 to have a certain fixing effect, so that the loudspeaker 2 is not easy to shake during audio playback.

The control circuit board 3 is also provided with a through hole 31 through which the loudspeaker 2 passes. The design of the through hole 31 leads to a higher utilization rate of the internal space of the speaker housing 1.

Magnet 4 is a ring-shaped N52 neodymium iron boron magnet 4. The limiting part includes an upper cavity provided at the bottom of the speaker body 12 and a lower cavity provided in the speaker bottom plate 13. Both the upper cavity and the lower cavity each include a circular boss 131 provided in the center and an annular positioning groove 132 provided on the periphery of the circular boss 131. The magnet 4 is arranged in the annular positioning groove 132 of the upper cavity and the lower cavity.

By arranging the magnet 4 between the bottom of the speaker body 12 and the speaker bottom plate 13, the magnet 4 and the loudspeaker 2 do not interfere with each other, and by arranging the magnet 4 in the annular positioning grooves 132 of the upper cavity and the lower cavity, it has a certain limit effect to the magnet 4 to prevent the speaker from shaking during use, and the magnet 4 adopts the neodymium iron boron magnet 4 realizing more firm attraction so that it will not easily fall.

The magnetically attractable Bluetooth speaker further includes a button assembly 5, and the speaker housing 1 is provided with a button hole 121 for installing the button assembly 5.

The design of the button assembly 5 makes the speaker more flexible to use, and the learning cost is low.

The button assembly 5 includes a button 51 and a connecting arm 52 arranged on each of both sides of the button 51. The connecting arm 52 is provided with a fixing hole, the speaker body 12 is provided with a positioning protrusion that operates in cooperation with the fixing hole in the connecting arm 52. The positioning protrusion is arranged in the fixing hole on the connecting arm 52, and the button 51 is arranged in the button hole 121 to achieve relative fixing between the button assembly 5 and the speaker body 12. The control circuit board 3 is provided with a button switch 32 that cooperates with the button 51. In this example, the button 51 is made of an elastic plastic material.

Through the cooperation of the connecting arms 52 and the speaker body 12, the button assembly 5 is more stably arranged on the speaker body 12.

The button assembly 5 further includes a button lamp circuit board 53, which is provided with light-emitting lamp beads. The button lamp circuit board 53 is electrically connected to the control circuit board 3. The button lamp circuit board 53 is fixedly arranged on the button 51. The button 51 is provided with a light-transmitting area 511 corresponding to the light-emitting lamp beads on the button lamp circuit board 53.

Through the design of the button lamp circuit board 53, the position of the button 51 can be easily identified even in a dark environment, which facilitates the operation of the speaker and plays a certain reminder role.

The speaker housing 1 is horn-shaped, and the horn-shaped design makes the speaker fit the palm of the hand more comfortably during the holding and placement.

The magnetically attractable Bluetooth speaker further includes a battery 6 for supplying power to the control circuit board 3, where the battery 6 is a lithium polymer battery.

The control circuit board 3 is provided with a charging interface 33 for charging the battery 6, and the speaker body 12 is provided with a charging hole 122 corresponding charging interface 33.

The magnetically attractable Bluetooth speaker further includes a dust plug 7 for preventing debris from entering the charging hole 122, and the dust plug 7 is arranged on the charging hole 122.

The magnetically attractable Bluetooth speaker further includes a silicone pad 8, which is fixedly arranged at the bottom of the speaker housing 1. The arrangement of the silicone pad 8 makes the speaker not easy to slide during placement, and to a certain extent solves the problem of friction and scratching between the speaker and the countertop.

The size of the silicone pad 8 is the same as the size of the circular boss 131 on the speaker bottom plate 13. The sizes of the silicone pad 8 and the circular boss 131 are the same, so that the magnetic attraction capability of the magnet 4 to metal is not affected to the greatest extent.

According to such a structure, by arranging the magnet 4 on the speaker housing 1, the user experience of the speaker can be greatly improved, so that the user can place it in different manners depending on their different needs. Compared with the traditional ordinary speakers that can only be placed on a horizontal plane or a surface with a small slope, the speaker provided by the present disclosure has better flexibility in use.

In the above embodiment, the magnet 4 is a ring-shaped N52 neodymium iron boron magnet 4. The magnet 4 is arranged between the annular positioning groove at the bottom of the speaker body 12 and the annular positioning groove 132 of the speaker bottom plate 13 to solve the problem that the speaker cannot be flexibly placed, resulting in poor user experience of the speaker. Other magnet configurations can also be used to solve the problem that the speaker cannot be flexibly placed. For example, a magnet can be divided into four smaller magnets, which are arranged in accordance with the upper N, left S, lower N, and right S, and correspondingly the bottom of the speaker body and the speaker bottom plate can each be provided with magnet positioning grooves matched with the four small magnets. Adopting this solution can also achieve the technical effects of the above solution.

The foregoing merely illustrates some illustrative embodiments of the present disclosure and are not intended to limit the present disclosure. Any modification, equivalent replacement, improvement, etc. made within the spirit and principle of the disclosure shall be included in the scope of protection of the disclosure.

What is claimed is:

1. A magnetically attractable Bluetooth speaker, comprising a speaker housing, a loudspeaker, a control circuit board, and a magnet, wherein the loudspeaker is electrically connected to the control circuit board, the speaker housing comprises a limiting part for fixing the magnet, and wherein the magnet is fixedly arranged in the limiting part and is arranged outside a magnetic circuit range of the loudspeaker.

2. The magnetically attractable Bluetooth speaker as recited in claim 1, wherein the speaker housing comprises a grille, a speaker body, and a speaker bottom plate, wherein the grille is connected to an upper end of the speaker body, a sound outlet of the loudspeaker is disposed to be oriented toward the grille, wherein the limiting part comprises an upper cavity provided at a bottom of the speaker body and a lower cavity provided at the speaker bottom plate.

3. The magnetically attractable Bluetooth speaker as recited in claim 2, further comprising a button assembly, wherein the speaker housing defines a button hole for installing the button assembly, the button assembly comprises a button and a connecting arm, the speaker housing comprises a connecting protrusion disposed therein that cooperates with the connecting arm, the button is fixedly connected to the connecting protrusion through the connecting arm, and is arranged in the button hole, and wherein the control circuit board comprises a key switch that operates in cooperation with the button.

4. The magnetically attractable Bluetooth speaker as recited in claim 3, wherein the button assembly further comprises a button lamp circuit board and a light-emitting lamp bead disposed on the button lamp circuit board, wherein the button lamp circuit board is electrically connected to the control circuit board and is fixedly arranged in the button, and wherein the button comprises a light-transmitting area, and light emitted by the light-emitting lamp bead is operative to pass through the light-transmitting area.

5. The magnetically attractable Bluetooth speaker as recited in claim 1, wherein a fixing platform for installing the loudspeaker is arranged in the speaker body, and a fixing hole is defined in the fixing platform allowing the loudspeaker to partially pass through.

6. The magnetically attractable Bluetooth speaker as recited in claim 5, wherein the control circuit board defines a through hole allowing the loudspeaker to partially pass through.

7. The magnetically attractable Bluetooth speaker as recited in claim 6, wherein the speaker housing is horn-shaped.

8. The magnetically attractable Bluetooth speaker as recited in claim 7, further comprising a battery configured for supplying power to the control circuit board, wherein the battery is a lithium polymer battery.

9. The magnetically attractable Bluetooth speaker as recited in claim 8, wherein the control circuit board comprises a charging interface configured for charging the battery, and wherein the speaker housing defines a charging hole corresponding to the charging interface.

10. The magnetically attractable Bluetooth speaker as recited in claim 9, further comprising a silicone pad fixedly arranged at the bottom of the speaker housing.

11. The magnetically attractable Bluetooth speaker as recited in claim 2, wherein a fixing platform for installing the loudspeaker is arranged in the speaker body, and a fixing hole is defined in the fixing platform allowing the loudspeaker to partially pass through.

12. The magnetically attractable Bluetooth speaker as recited in claim 3, wherein a fixing platform for installing the loudspeaker is arranged in the speaker body, and a fixing hole is defined in the fixing platform allowing the loudspeaker to partially pass through.

13. The magnetically attractable Bluetooth speaker as recited in claim 4, wherein a fixing platform for installing the loudspeaker is arranged in the speaker body, and a fixing hole is defined in the fixing platform allowing the loudspeaker to partially pass through.
